(19) United States
(12) Patent Application Publication
(10) Pub. No.: US 2003/0000046 A1
(43) Pub. Date: Jan. 2, 2003

(54) Free positioning hinge

(76) Inventor: Chia Yu Liao, Taipei (TW)

Correspondence Address: Chia Yu Liao, 235 Chung - Ho, Box 8-24, Taipei, TW

(21) Appl. No.: 10/042,456

(22) Filed: Jan. 10, 2002

(30) Foreign Application Priority Data
Jun. 29, 2001 (TW) 090210884

(51) Int. Cl. E05F 1/08

(52) U.S. Cl. 16/307

(57) ABSTRACT

A free positioning hinge is especially used to a notebook computer, an electronic dictionary, a personal digital assistant, etc. for opening covers of these devices, or is used to a rear view mirror of a car. The free positioning hinge is formed by pivotally engaging a rotary shaft with a sleeve. The sleeve is formed by a plurality of stacking closed pads. Each pad has an axial hole. A hollow neck extends from the axial hole and two hollow shoulders are extended from the neck, thereby, two flexible arm portions being formed between the axial hole, the two shoulders, and the neck. The friction surface of the sleeve has a preferred flexibility so that it is difficult to damage the components assembled thereto. Furthermore, oil stored in the holes may provide a proper lubrication ability so as to prolong the lifetime of the device.

### FIELD OF THE INVENTION

The present invention relates to a hinge structure, and particularly to a free positioning hinge.

### BACKGROUND OF THE INVENTION

The free-positioning hinge is widely used in assembling the machine body of electronic devices, for example, notebook computers, personal digital assistants, etc., or rear view mirrors used in vehicles having two portions which are pivotally connected through a hinge. In these devices, as a display is opened to a position, it can be positioned in that position so not to fall down due to the gravitational force. In this hinge, the friction force between a rotary unit and a stator unit is utilized to cancel the twisting force of the gravitational force. Therefore, the size of the frictional force is a key point in designing the hinge. If the friction force is too large, not only a large force is necessary to open the device, but also the wearing between two portions of the device is also large. If the friction force is too smaller, then it is very possible that one portion slides with respect to the other portion.

Other than the precision of the components, the construction is also an important consideration about the friction (twisting force) of a hinge.

In the prior art, a hinge is mainly formed by pivotally connecting a sleeve with a rotary shaft. However, these devices are lack of a means for resisting the twisting force induced from the two components. Once the volume of the machine body or the weight of the device to be installed with the hinge is changed, the hinge must be further designed. Therefore, new molds are required. However, currently, the machine bodies of electronic devices are changed frequently. Thus, the prior design is not economical. Next, the prior designs have no space for receiving lubricating oil. Therefore, the lubricating oil can not be contained in the friction surface for a long time period and thus the effect of lubrication is reduced day by day so as to increase the wearing between two connecting components. After being used for a longer time, the friction force is not sufficient to support the twisting force.

To improve the defect in the prior art, in Taiwan Patent No. 90205536, filed in Apr. 10, 2001, disclosed by the inventor of the present invention, a plurality of triangular pads are stacked to form a sleeve. A round main axial hole is formed at the center of the pad. At least one auxiliary hole is formed aside the main axial hole for storing oil. Therefore, a friction force is generated as an elastic adjusting mechanism. Moreover, by the auxiliary hole to store lubricating oil, the friction surface has a preferred lubricating effect so as to prolong the lifetime of a device.

However, the inventor discovers that the prior design has some disadvantages, for example, the friction surface between the rotary shaft 1 and the axial hole 211 of the pad 21 are closed completely. Although the structure is rigid, it is lack of flexibility. If a very large twisting force generates, it is easy that some components will be destroyed. Furthermore, since the friction surface is closed, as the rotary shaft rotates, an outer cover seat 31 of the sleeve 2 will be affected synchronously so as to increase the resistance force.

### SUMMARY OF THE INVENTION

Accordingly, the primary object of the present invention is to provide a free positioning hinge which is especially used to a notebook computer, an electronic dictionary, a personal digital assistant, etc. for opening covers of these devices, or is used to a rear view mirror of a car. The free positioning hinge is formed by pivotally engaging a rotary shaft with a sleeve. The sleeve is formed by a plurality of stacking closed pads. Each pad has an axial hole. A hollow neck extends from the axial hole and two hollow shoulders are extended from the neck, thereby, two flexible arm portions being formed between the axial hole, the two shoulders, and the neck. The friction surface of the sleeve has a preferred flexibility so that it is difficult for the components assembled thereto to break. Furthermore, oil stored in the holes may provide a proper lubrication ability so as to prolong the lifetime of the device.

The various objects and advantages of the present invention will be more readily understood from the following detailed description when read in conjunction with the appended drawing.

### BRIEF DESCRIPTION OF THE DRAWINGS

FIG. 1 is an exploded perspective view of the present invention.

FIG. 2 is an assembled perspective view of the present invention.

FIG. 3 is an exploded view showing an embodiment that the present invention is utilized with other device.

FIG. 4 shows an assembly of FIG. 3.

FIG. 5 shows a second embodiment of the pad of the present invention.

### DETAILED DESCRIPTION OF THE PREFERRED EMBODIMENTS

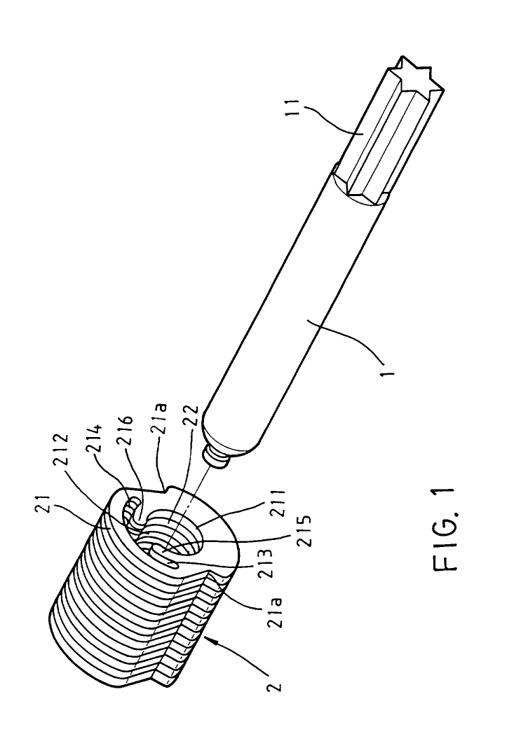

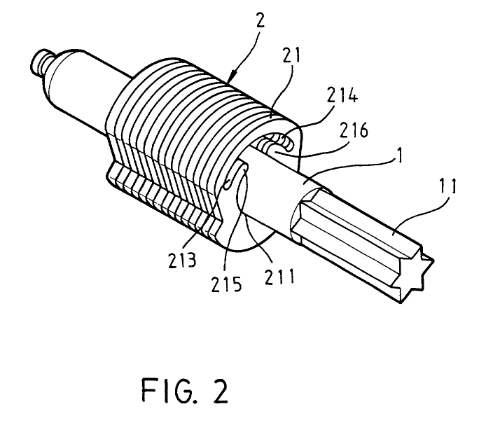

With reference to FIGS. 1 and 2, a free positioning hinge of the present invention is illustrated, which is especially used to a notebook computer, an electronic dictionary, a personal digital assistant (PDA), etc. for opening covers of these devices.

The free positioning hinge of the present invention is formed by a rotary shaft 1 and a sleeve 2. The sleeve 2 is formed by stacking a plurality of closing type pads 21. In the present invention, the shape of each pad 21 is similar to a round shape. Each of two sides at the periphery thereof is reduced inwards to form a respective notch as a positioning portion 21a. The positioning portion 21a is used to be engaged with a seat 3 described hereinafter.

The pad 21 mainly includes an axial hole 211 for being inserted by the rotary shaft 1. The axial hole 211 extends to form a neck 212 and two shoulders 213, 214. Thereby, two friction arm portions 215, 216 with a preferred flexibility are formed between the axial hole 211 and the two shoulders 213, 214.

The neck 212 and the two shoulders 213, 214 extending from the axial hole 211 can be used as lubricating holes. Therefore, as the rotary shaft 1 passes through the sleeve 2 so as to generate a friction force, the friction surface 22 of the sleeve 2 has a preferred flexibility so that it is difficult for the components assembled thereto to break. Furthermore, oil stored in the holes may provide a proper lubrication ability so as to prolong the lifetime of the device.

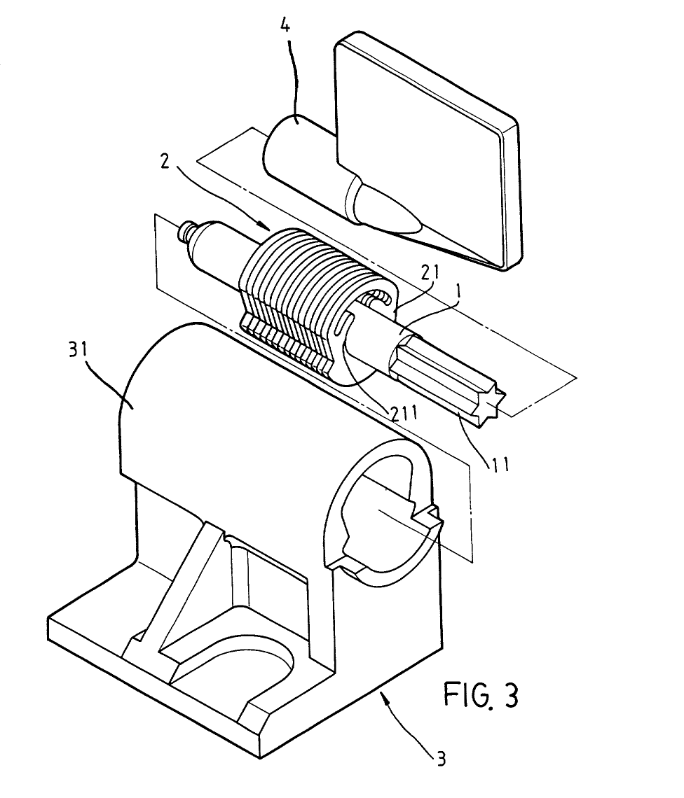

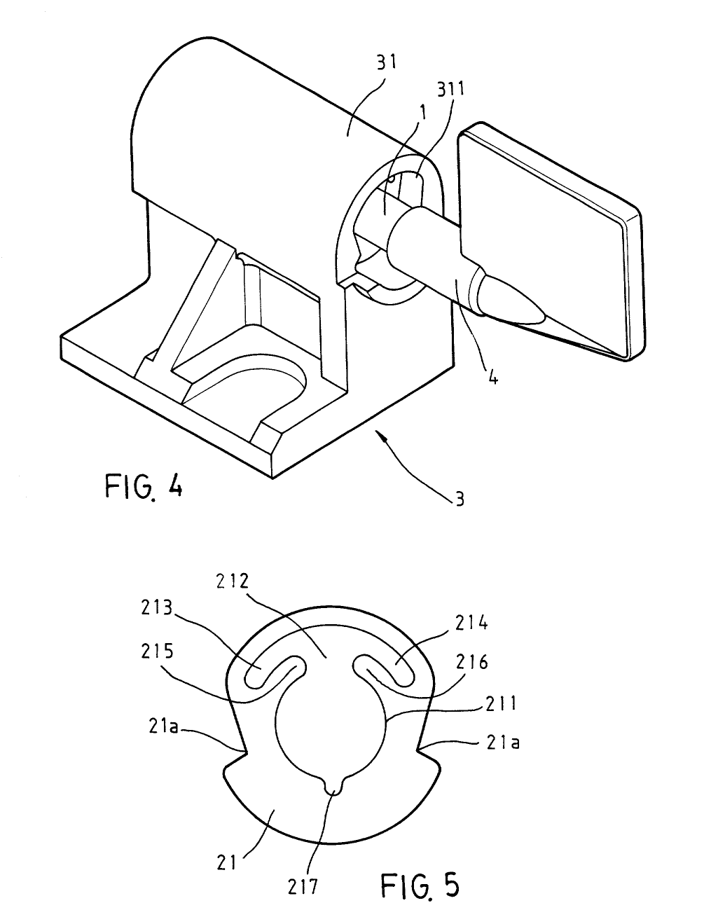

Referring to FIGS. 3 and 4, an application about a preferred embodiment of the present invention is illustrated. It can be known from the drawings that the seat 3 of the main machine of an open-able electronic device (such as a notebook computer, a PDA, etc.) encloses and thus fixes the sleeve 2 by a cover 31. After the pads 21 are stacked one by one through the alignment of the positioning portion 21a. The sleeve 2 is inserted into the cover seat 31 with respect to the engaging hole 311 of the cover seat 31 and is positioned therein so not to rotate. The movable end 4 (such as a panel, a display, etc.) of the open-able electronic device is connected to a jointing portion 11 of the rotary shaft 1. When the movable end 4 rotates, the rotary shaft 1 is driven to rotate, then the twisting force due to the weight of the movable end 4 is cancelled by the friction force generated between the rotary shaft 1 and the sleeve 2. Therefore, the movable end 4 can be positioned freely.

Since in the present invention, the sleeve 2 has a stacked structure. The length thereof is determined by the number of the pads 21. That is, if a larger friction force is required, the number of the pads 21 can be increased, and vice versa.

Referring to FIG. 5, if the oil storage space of the sleeve 2 is not sufficient, an auxiliary hole 217 can be formed near the axial hole 211 of each pad 21 so as to have a preferred lubricating effect.

The present invention are thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A free positioning hinge formed by pivotally engaging a rotary shaft with a sleeve; said rotary shaft being connected to an open-able element of a device; said sleeve being confined to a connecting seat of said device; characterized in that: said sleeve is formed by a plurality of stacking closed pads; each pad has an axial hole for being inserted by said rotary shaft; a hollow neck extends from said axial hole and two hollow shoulders extends from said neck, thereby, two flexible arm portions being formed between said axial hole, said two shoulders, and said neck.

2. The free positioning hinge as claimed in claim 1, wherein said hollow neck and said two hollow shoulders are utilized as lubricating oil holes.

3. The free positioning hinge as claimed in claim 1, wherein each pad has a round-like shape, an periphery thereof is formed with a positioning portion for being engaged to said connecting seat of said device.

4. The free positioning hinge as claimed in claim 3, wherein said positioning portion is formed by two reduced notches at two sides of said periphery of each said pad.
